(19) United States
(12) Patent Application Publication
(10) Pub. No.: US 2012/0088673 A1
(43) Pub. Date: Apr. 12, 2012

(54) Growth inhibition of perennial forage grasses with Pyroxsulam

(75) Inventor: Donald D. Hare, Sherwood Park (CA)

(73) Assignee: DOW AGROSCIENCES LLC, Indianapolis, IN (US)

(21) Appl. No.: 13/270,281

(22) Filed: Oct. 11, 2011

Related U.S. Application Data
(60) Provisional application No. 61/392,142, filed on Oct. 12, 2010.

(51) Int. Cl. A01N 43/90; A01P 21/00

(52) U.S. Cl. 504/241

(57) ABSTRACT

Pyroxsulam inhibits the grown of perennial forage grasses, reducing the need for mowing.

### CROSS REFERENCE TO RELATED APPLICATIONS

This application claims the benefit of U.S. Provisional Patent Application Ser. No. 61/392,142 filed Oct. 12, 2010.

### FIELD OF THE INVENTION

This invention concerns the use of pyroxsulam as a plant growth regulator.

### BACKGROUND OF THE INVENTION

The present invention concerns a method of controlling or inhibiting the growth of certain perennial forage grasses, particularly in areas covered by perennial forage grass cover, including non-crop areas and range and pasture. The use of ground cover is highly desirable in areas such as parkland, rights-of-way, roadsides, pipelines, transmission lines, airports and other areas considered as industrial vegetation management areas for prevention of erosion and for aesthetic reasons. Grasses are often the cover of choice, as they grow well in a range of sunlight availability, can use relatively little water, and are perennial. They do suffer from the problem of needing to be mowed or cut frequently in order to keep their height to a desired level for safety and aesthetic reasons, which can result in increased labor costs for agencies managing these areas.

The plant growth regulating compound forming the composition of this invention is known in the art for its effect as an herbicide. Pyroxsulam, N-(5,7-dimethoxy[1,2,4]-triazolo[1,5-a]pyrimidin-2-yl)-2-methoxy-4-(trifluoromethyl)-3-pyridinesulfonamide, is a triazolopyrimidine sulfonamide herbicide, and its herbicidal activity is described in The Pesticide Manual, Fifteenth Edition, 2009. Pyroxsulam provides broad-spectrum, post-emergence annual grass and broadleaf weed control in cereals.

### SUMMARY OF THE INVENTION

The present invention concerns a method of inhibiting the growth of perennial forage grasses which comprises contacting the perennial forage grass or the locus thereof with a growth inhibiting amount of pyroxsulam. Pyroxsulam is particularly useful for inhibiting the growth of creeping red Fescue (FESRU), Quackgrass (ARGGE), meadow Bromegrass (BROCO) and smooth Bromegrass (BROIN).

### DETAILED DESCRIPTION OF THE INVENTION

The term plant growth regulator is used herein to mean an active ingredient that temporarily retards or suppresses the growth of a plant, preferably without necrosis. A plant growth-regulating amount is an amount of active ingredient which causes the reversible stunting effect.

Plant growth regulation is exhibited by the compound of the invention when it is applied to the foliage or locus of the plant. The effect observed depends upon the perennial grass species to be controlled, the application parameters of dilution, the particle size of solid components, the environmental conditions at the time of use, the specific adjuvants and carriers employed, the soil type, and the like, as well as the amount of chemical applied. These and other factors can be adjusted as is known in the art to promote a higher or lower degree of plant growth regulation. Generally, it is preferred to apply the composition of the present invention postemergence, after emergence of the grasses to achieve the desired regulation of the growth of the plant, while maintaining the life of the plant.

The rate at which the plant growth regulator is applied will depend upon the particular type of grass to be controlled, the degree of control required, and the timing and method of application. In general, the composition of the invention can be applied at an application rate from about 7.5 grams pyroxsulam per hectare (g ai/ha) to about 50 g ai/ha, preferably from about 15 g ai/ha to about 30 g ai/ha.

The present invention can be applied in conjunction with one or more other herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the present invention include: 2,4-D, ametryn, amidosulfuron, aminocarbazone, aminocyclopyrachlor, aminopyralid, amitrol, asulam, atrazine, bentazon, bromacil, butafenacil, carfentrazone-ethyl, chlorflurenol, chlormequat, chlorpropham, chlorsulfuron, chlortoluron, cinosulfuron, clethodim, clopyralid, cyclosulfamuron, dicamba, dichlobenil, dichlorprop-P, diclosulam, diflufenican, diflufenzopyr, diquat, dithiopyr, diuron, flazasulfuron, fluazifop, flumioxazin, flumetsulam, fluroxypyr, fosamine, glyphosate, hexazinone, imazamox, imazapic, imazapyr, imazaquin, imazethapyr, imazosulfuron, iodosulfuron, isoxaben, MCPA, MCPB, MSMA, metsulfuron-methyl, nicosulfuron, oxyfluorfen, paraquat, pendimethalin, picloram, prometon, pyroxsulam, pyrithiobac-sodium, quinclorac, rimsulfuron, saflufenacil, sethoxydim, sulfometuron, sulfosate, sulfosulfuron, tebuthiuron, terbacil, thiazopyr, thifensulfuron, triasulfuron, tribenuron and triclopyr.

The composition of the present invention can be employed in combination with known herbicide safeners such as cloquintocet (mexyl), benoxacor, benthiocarb, brassinolide, cyometrinil, daimuron, dichlormid, dicyclonon, dimepiperate, disulfoton, fenchlorazole-ethyl, fenclorim, flurazole, fluxofenim, furilazole, hairpin proteins, isoxadifen-ethyl, mefenpyr-diethyl, MG 191, MON 4660, naphthalic anhydride (NA), oxabetrinil, R29148 and N-phenylsulfonylbenzoic acid amides.

While it is possible to utilize the compound of the present invention directly as a plant growth regulator, it is preferable to use it in mixtures containing a plant growth regulating amount of the compound along with at least one agriculturally acceptable adjuvant or carrier. Suitable adjuvants or carriers should not be phytotoxic to the perennial grasses, particularly at the concentrations employed in applying the compositions for grass growth regulation, and should not react chemically with the compounds or other composition ingredients. Such mixtures can be designed for application directly to grasses or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a pre-mix or tank mixed.

Suitable agricultural adjuvants and carriers that are useful in preparing the plant growth regulator of the invention are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils.

Other additives commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like.

The concentration of the active ingredients in the composition of the present invention is generally from 0.001 to 98 percent by weight. Concentrations from 5 to 90 percent by weight are often employed. In compositions designed to be employed as concentrates, the active ingredients are generally present in a concentration from 5 to 98 weight percent, preferably 5 to 90 weight percent. Such compositions are typically diluted with an inert carrier, such as water, before application. The diluted compositions usually applied to grasses or the locus of grasses generally contain 0.0001 to 1 weight percent active ingredient and preferably contain 0.001 to 0.1 weight percent.

The present compositions can be applied to grasses or their locus by the use of conventional ground or aerial dusters, sprayers, and granule applicators, by addition to irrigation water, and by other conventional means known to those skilled in the art.

### EXAMPLES

Trials were conducted under field conditions in Canada. Trial sites were located in perennial forage grass areas. Forage grasses tested included: Bromegrass, Timothy Fescue and Wheatgrass species, including: meadow Bromegrass (BROCO, Bromus commutatus), smooth Brome grass (BROIN, Bromus inermus), Timothy (PHLPR, Phleum pretense), creeping red Fescue (FESRU, Festuca rubra), Tall Fescue (FESAR, Festuca arundinacea), and Western Wheatgrass (AGRSM, Agropyron smithii). The grasses were grown using normal cultural practices for fertilization, seeding, and maintenance to ensure good growth of the grasses. The trials were conducted using normal research methodology. Trial plots were between 2 to 5 meters (m) wide by 5 to 20 m long. All treatments were applied using a randomized complete block trial design with 3 or 4 replications per treatment. The trial sites had populations of homogeneous or heterogeneous perennial forage grass species present. Treatments consisted of pyroxsulam formulations (Simplicity® (trademark of Dow AgroSciences LLC for pyroxsulam+cloquintocet) or water-dispersible formulations of pyroxsulam) alone, or in tank mixes with Milestone® herbicide (trademark of Dow AgroSciences LLC for aminopyralid) or ClearView® herbicide (trademark of Dow AgroSciences LLC for aminopyralid+metsulfuron-methyl) with or without 2,4-D ester applied in water. Adjuvants were applied at 0.2% to 0.5% V/V. The application volumes were between 50 to 200 liters per hectare (L/ha). All application were made using precision gas hand sprayers or calibrated ATV sprayer using a 2 or 5 m boom using flat fan (80° or 110°) nozzles to broadcast the treatments post-emergent on the vegetation or soil.

The treated plots and control plots were rated blind at various intervals after application. Ratings were based on Percent (%) Visual growth suppression (reduction) from untreated grass, where 100% corresponds to no suppression verses untreated growth, and 0% corresponds to complete suppression or growth inhibition compared to the untreated grass growth. Quantitative measurements were also taken at various intervals after application, and measured in cm or inches height of leaf blade top height from the ground.

The plant growth regulator tested, application rates, plant species tested, and results are given in Tables 1-3.

TABLE 1
Control of Meadow Brome Grass with Pyroxsulam at 15 and 30 g ai/ha.

| | Treatment | | | | | |
|---|---|---|---|---|---|---|
| | Height (cm)* | | | Height (% of Untreated)* | | |
| Days after | | 15 g | 30 g | | 15 g | 30 g |
| Application | Untreated | ai/ha | ai/ha | Untreated | ai/ha | ai/ha |
| 0 | 20 | 20 | 20 | 100.0 | 100.0 | 100.0 |
| 7 | 35 | 20 | 20 | 100.0 | 57.1 | 57.1 |
| 14 | 50 | 25 | 25 | 100.0 | 50.0 | 50.0 |
| 21 | 63 | 30 | 28 | 100.0 | 47.6 | 44.4 |
| 30 | 60 | 27 | 25 | 100.0 | 45.0 | 41.7 |
| 37 | 65 | 28 | 25 | 100.0 | 43.1 | 38.5 |
| 42 | 73 | 33 | 33 | 100.0 | 45.2 | 45.2 |
| 50 | 78 | 42 | 40 | 100.0 | 53.8 | 51.3 |
| 56 | 82 | 43 | 42 | 100.0 | 52.4 | 51.2 |
| 65 | 82 | 48 | 43 | 100.0 | 58.5 | 52.4 |
| 72 | 82 | 63 | 47 | 100.0 | 76.8 | 57.3 |

*Height = mean of 3 replicates

TABLE 2
Biomass Reduction Pyroxsulam-Treated vs Untreated Grass - 30 DAA
All grass species combined (CRFescue, Brome Grass, Quackgrass)

| | Biomass |
|---|---|
| Pyroxsulam | reduction |
| (g/ha) | (%) |
| 30 | 38 |
| 15 | 40 |
| 0 | 0 |

TABLE 3
Percent Growth Inhibition for Creeping Red Fescue Treated with
Pyroxsulam

| | % Growth | |
|---|---|---|
| | Inhibition | |
| | 15 g | 30 g |
| Weeks | ai/ha | ai/ha |
| 1 | 0 | 0 |
| 2 | 7 | 14 |
| 3 | 35 | 35 |
| 4 | 30 | 32 |
| 5 | 23 | 32 |
| 6 | 21 | 21 |
| 7 | 15 | 19 |
| 8 | 4 | 12 |
| 9 | 8 | 4 |
| 10 | 12 | 12 |

What is claimed:

1. A method of inhibiting the growth of perennial forage grasses which comprises contacting the perennial forage grass or the locus thereof with a growth inhibiting amount of pyroxsulam.

2. The method of claim 1 in which pyroxsulam is applied at a rate from about 7.5 grams per hectare (g ai/ha) to about 50 g ai/ha.
